(19) United States
(12) Patent Application Publication
(10) Pub. No.: US 2025/0265859 A1
(43) Pub. Date: Aug. 21, 2025

(54) METHOD OF PERFORMING INDIVIDUAL IDENTIFICATION OF ANIMAL, AND COMPUTER PROGRAM

(71) Applicant: SEIKO EPSON CORPORATION, TOKYO (JP)

(72) Inventor: Hikaru KURASAWA, Matsumoto-shi (JP)

(21) Appl. No.: 19/054,946

(22) Filed: Feb. 17, 2025

(30) Foreign Application Priority Data
Feb. 16, 2024 (JP) 2024-021659

(51) Int. Cl. G06V 40/10

(52) U.S. Cl. CPC G06V 40/10; G06V 2201/07

(57) ABSTRACT

A method of the present disclosure includes (a) acquiring a target image related to a back of the target animal, (b) determining an embedding vector from the target image by using a deep metric learning model, (c) calculating a distance between the registered embedding vector and the embedding vector by using registered data including a registered embedding vector generated in advance for each of a plurality of registered individuals, and (d) determining an individual of the target animal from among the plurality of registered individuals by using the distance.

### BACKGROUND

The present application is based on, and claims priority from JP Application Serial Number 2024-021659, filed Feb. 16, 2024, the disclosure of which is hereby incorporated by reference herein in its entirety.

### 1. Technical Field

The present disclosure relates to a method of performing individual identification of animal, and a computer program.

### 2. Related Art

JP-A-2022-48464 discloses a technique of cow nose print image matching. This known technology performs nose print image matching by extracting a nose print image from a face image of a cow, acquiring a feature vector of the nose print image by using a neural network for nose print image classification, and calculating the similarity between the feature vector and known feature vectors.

However, this known technology requires a high-resolution face image that allows for identification of the minute structure of the nose print, but it is difficult to acquire such a face image. For example, for cows walking continuously, it is difficult to stop the movement of the cows to capture images. Such problems have been not limited to cows, but have been common to the individual identification of other animals such as pigs. In view of this, there is a demand for techniques that can perform individual identification using features other than nose prints.

### SUMMARY

A first aspect of the present disclosure provides a method of performing individual identification of a target animal. The method including (a) acquiring a target image related to a back of the target animal, (b) determining an embedding vector from the target image by using a deep metric learning model, (c) calculating a distance between the registered embedding vector and the embedding vector by using registered data including a registered embedding vector generated in advance for each of a plurality of registered individuals, and (d) determining an individual of the target animal from among the plurality of registered individuals by using the distance.

A second aspect of the present disclosure provides a non-transitory computer-readable storage medium storing a computer program, the computer program being configured to cause a processor to execute a process of performing individual identification of target animal. The computer program causes the processor to execute (a) a process of acquiring a target image related to a back of the target animal, (b) a process of determining an embedding vector from the target image by using a deep metric learning model, (c) a process of calculating a distance between the registered embedding vector and the embedding vector by using registered data including a registered embedding vector generated in advance for each of a plurality of registered individuals, and (d) a process of determining an individual of the target animal from among the plurality of registered individuals by using the distance.

### BRIEF DESCRIPTION OF THE DRAWINGS

FIG. 1 is a block diagram illustrating a configuration of an individual identification system.

FIG. 2 is a flowchart of a procedure of training a deep metric learning model and creating registered data.

FIG. 3 is a flowchart of a specific procedure of step S10.

FIG. 4 is an explanatory diagram illustrating details of a process of generating a target image at step S10.

FIG. 5 is a flowchart of a procedure of an individual identification process in a first embodiment.

FIG. 6 is a flowchart of a specific procedure of step S140 in the first embodiment.

FIG. 7 is an explanatory diagram illustrating details of a process step S140 in the first embodiment.

FIG. 8 is a flowchart of a procedure of a registration update process.

FIG. 9 is a flowchart of a specific procedure of step S140 in a second embodiment.

FIG. 10 is an explanatory diagram illustrating details of a process of step S140 in the second embodiment.

FIG. 11 is a flowchart of a procedure of an individual identification process in a third embodiment.

FIG. 12 is an explanatory diagram illustrating details of distance calculation in the third embodiment.

### DESCRIPTION OF EMBODIMENTS

### A. First Embodiment

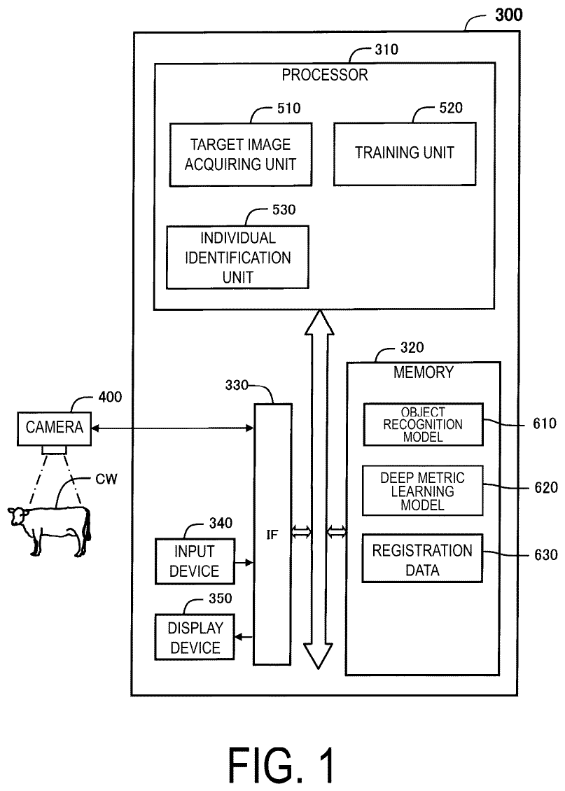

FIG. 1 is an explanatory diagram illustrating a configuration of an individual identification system in a first embodiment. This individual identification system includes an information processing device 300 and a camera 400. In this embodiment, the target of the individual identification process is a cow CW. It should be noted that the processing target may be other animals than cows such as pigs, dogs, and cats.

The camera 400 is for capturing images of the cow CW that is a target of an individual identification process. The camera 400 is installed to capture the back of the cow CW from above the cow CW. As the camera 400, a video camcorder for capturing moving images or a still picture camera for capturing still pictures may be used. In addition, preferably the camera 400 is a depth camera for capturing depth images. It should be noted that a camera for capturing RGB images, not depth images, may be used. In this embodiment, moving images of the back of the cow CW are captured by using the camera 400 for capturing depth images. Depth images are preferable because they are less susceptible to lighting conditions and dirt than RGB images, allowing for more accurate individual identification of the cow CW.

The information processing device 300 executes individual identification of the cow CW by using an image related to the back of the cow CW captured by the camera 400. The information processing device 300 includes a processor 310, a memory 320, an interface circuit 330, and an input device 340 and a display device 350 coupled with the interface circuit 330. The camera 400 is also coupled with the interface circuit 330. The processor 310 has not only a function of executing processes elaborated below, but also a function of displaying on the display device 350 data obtained through the processes and data generated during the processes. The information processing device 300 can be implemented with a computer such as a personal computer.

The processor 310 has functions of a target image acquiring unit 510, a training unit 520, and an individual identification unit 530. The target image acquiring unit 510 acquires a plurality of target images from the back image captured by the camera 400. The training unit 520 executes metric training of a deep metric learning model 620. The individual identification unit 530 executes individual identification of the cow CW by using the trained deep metric learning model 620. The functions of these units are implemented when the processor 310 executes computer programs stored in the memory 320. It should be noted that some of these functions may be implemented by hardware circuits. The processor of the present disclosure encompasses such hardware circuits. In addition, one or a plurality of processors that execute various processes may be a processor included in one or a plurality of remote computers coupled through a network.

The memory 320 stores an object recognition model 610, the deep metric learning model 620, and registered data 630. The object recognition model 610 is a machine learning model that outputs a plurality of key points, which are geometrical feature points of the cow CW, with an image of the cow CW as an input. This embodiment assumes that the object recognition model 610 is a trained model. The object recognition model 610 may be referred to as “feature recognition model”.

The deep metric learning model 620 is a machine learning model that outputs an embedding vector with an image of the cow CW as an input. The embedding vector is also referred to as “feature vector”. The deep metric learning model 620 may be configured using FaceNet, for example.

The registered data 630 is a database in which the individual ID of the cow CW and a plurality of embedding vectors obtained using the deep metric learning model 620 are registered for each of a plurality of registered individuals. The embedding vector registered in the registered data 630 is referred to as “registered embedding vector”.

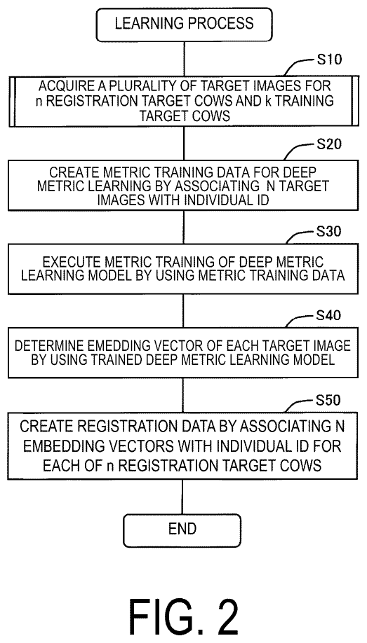

FIG. 2 is a flowchart illustrating a procedure of training the deep metric learning model 620 and creating the registered data 630. The following description assumes that when n is an integer of 2 or greater, n registration target cows are registered in the registered data 630. In this embodiment, n registration target cows are of the same breed.

At step S10, the target image acquiring unit 510 acquires a plurality of target images related to the back for each of n registration target cows and k training target cows. Here, n and k are integers of 2 or greater. The “training target cow” means a cow used for creating training data of the deep metric learning model 620. In deep metric learning, it is desirable to train a neural network by using training data different from the registered data 630 from a view point of robustness. It is also desirable to create training data to include more data than the registered data 630. Accordingly, it is preferable to set k to a value greater than n. It should be noted that some of training target cows may be registration target cows. In addition, n=k may be set such that the same cows are used as the training target cows and the registration target cows. The number of target images to be acquired from the individual cow may be set to a fixed value N, or may be set to a different number for each individual cow. Here, N is an integer of 1 or greater, but N is preferably 2 or greater. For example, it is preferable to set N to a value in a range from 5 to 30.

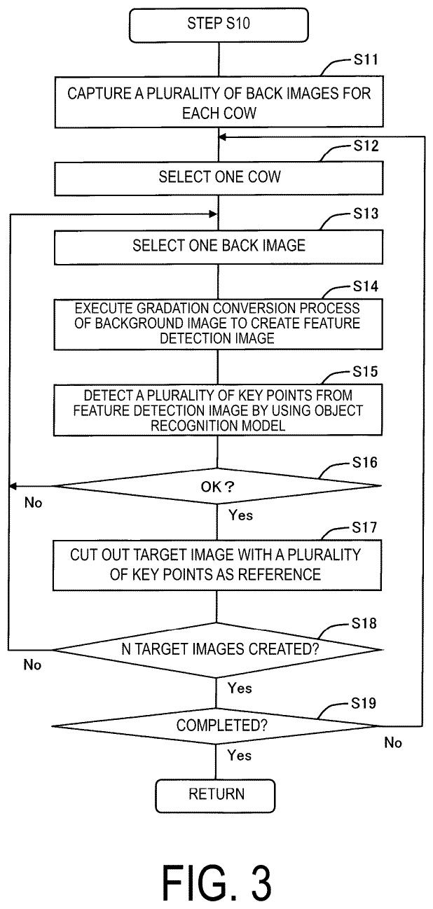

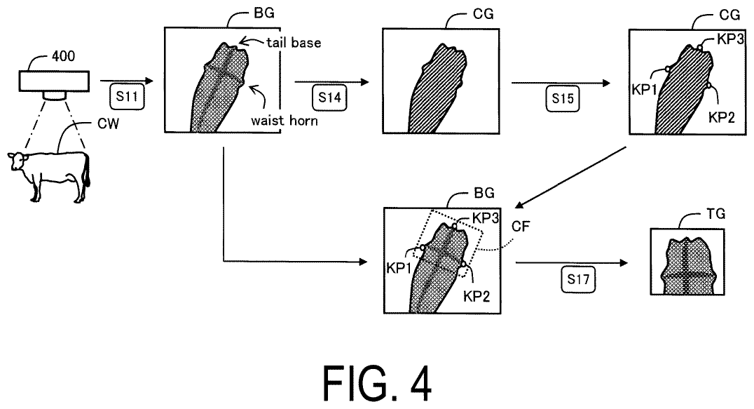

FIG. 3 is a flowchart illustrating a specific procedure of step S10, and FIG. 4 is an explanatory diagram illustrating details of that process. FIG. 4 illustrates some step numbers of FIG. 3.

At step S11, the target image acquiring unit 510 captures a plurality of the back images BG related to the back for each individual cow by using the camera 400. This image capturing can be performed when individual cows sequentially pass below the camera 400, for example. In the case where a moving image is captured, a plurality of frame images is selected as the back image BG from the moving image. This selection can be performed by automatically selecting a frame image including a rear portion of a registration target cow by using an annotation tool, for example. Alternatively, the operator may manually perform the selection.

The back image BG illustrated in FIG. 4 includes the rear portion of the cow CW including the pin bones and tail base. Since the individual cows CW are characterized by the shape of the rear portion of the cow CW, the back image BG preferably includes the rear portion of the cow CW including the pin bones and tail base.

At step S12, the target image acquiring unit 510 selects one cow as a processing target from among n registration target cows and k training target cows. At step S13, the target image acquiring unit 510 selects one back image BG as a processing target from among a plurality of the back images BG. At step S14, the target image acquiring unit 510 creates a feature detection image CG by executing a gradation conversion process of the back image BG. This gradation conversion process is a process of extracting the gradation range in which the outline of the cow can be easily detected in all gradations of the back image BG, and converting it into a predetermined number of gradation images. For example, in the case where the back image BG as a depth image is an image with 2, 400 gradations, the feature detection image CG may be created by extracting intermediate 512 gradations and compressing them into 256 gradations. It should be noted that step S14 may be omitted.

At step S15, the target image acquiring unit 510 detects a plurality of key points from the feature detection image CG by using the object recognition model 610. In the example illustrated in FIG. 4, two key points KP1 and KP2 are detected at the position of the pin bone of the cow CW, and one key point KP3 is detected at the position of the tail base. These key points KP1 to KP3 are feature points located on the outlines of the cow CW. The object recognition model 610 is a machine learning model that outputs the plurality of key points KP1 to KP3 with the feature detection image CG as the input. It should be noted that the object recognition model 610 may be configured to recognize key points representing other positions. The object recognition model 610 may be configured using DeepLabCut and/or ResNet, which are deep learning models. The object recognition model 610 may be configured using other machine learning models.

At step S16, the target image acquiring unit 510 determines whether a predetermined number of key points KP1 to KP3 has been detected. When the predetermined number of key points KP1 to KP3 has not been detected, the process is returned to step S13, and another back image BG is selected as the processing target, and, the processes subsequent to step S14 are performed again. When the predetermined number of key points KP1 to KP3 has been detected, the process proceeds to step S17.

At step S17, the target image acquiring unit 510 cuts out a target image TG from the back image BG with the plurality of key points KP1 to KP3 as a reference. The target image TG is an image including a feature portion of the back of the cow. The example illustrated in FIG. 4 illustrates a state where a cut-out frame CF with the key points KP1 to KP3 as a reference is set in the back image BG, and the target image TG cut out in accordance with the cut-out frame CF. At this time, it is preferable to set the direction and/or size of the pin bones of the cow CW to desired values in target images TG by rotating and/or resizing the target image TG. In addition, the pixel value of the target image TG may be subjected to normalization. The normalization is a process of normalizing the pixel value of the minimum depth value to 1.0 and the pixel value of the maximum depth value to 0, and further converting the pixel values in a range of 0 to 1.0 into 0 to 255 gradations, for example. Note that the back image BG may be directly used as the target image TG by omitting steps S14 to S17.

At step S18, the target image acquiring unit 510 determines whether N target images TG have been created for one COW. When N target images TG have not been created, the process is returned to step S13, and another back image BG is selected as the processing target, and, the processes subsequent to step S14 are performed again. When N target images TG have been created, the process proceeds to step S19.

At step S19, the target image acquiring unit 510 determines whether the process has been completed for all of n registration target cows and k training target cows. When the process has not been completed for all cows, the process is returned to step S12, and another cow is selected as a processing target, and, the processes subsequent to step S13 are executed again. When the process has been completed for all cows, the process of step S10 is terminated.

At step S20 in FIG. 2, the training unit 520 creates the distance training data for deep distance training by associating with an individual ID the N target images TG acquired for each training target cow. At step S30, the training unit 520 executes distance training of the deep metric learning model 620 by using the distance training data. This distance training is a process of adjusting internal parameters of the deep metric learning model 620 such that the embedding vectors output from the deep metric learning model 620 have shorter distances for the same individual and longer distances for different individuals. As the distance between the embedding vectors, for example, the Euclidean distance between the vectors or the angle between the vectors may be used.

At step S40, the training unit 520 determines the embedding vector for each target image TG by sequentially inputting N target images TG related to each registration target cow into the trained deep metric learning model 620. As a result, N embedding vectors are obtained for each registration target cow. At step S50, the training unit 520 creates the registered data 630 by associating N embedding vectors with the individual ID for each of n registration target cows.

Through the above-described learning process of FIG. 2, the trained deep metric learning model 620 and the registered data 630 related to n registration target cows are obtained. In the following description, the registration target cow is referred to as “registered individual”. In addition, the embedding vector registered in the registered data 630 is referred to as “registered embedding vector”.

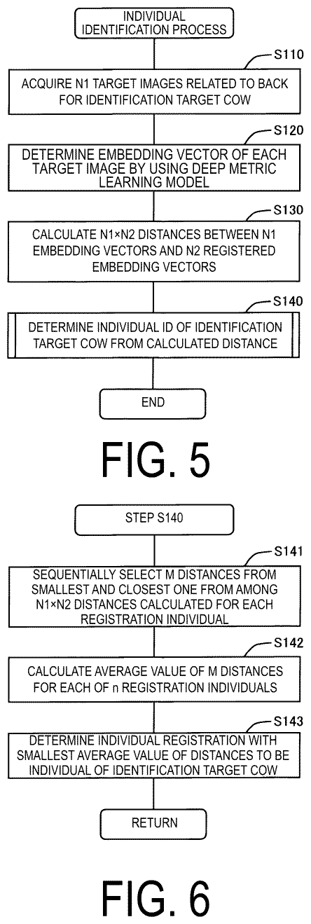

FIG. 5 is a flowchart illustrating a procedure of the individual identification process. Preferably, the individual identification process is periodically implemented for all cows raised on the same farm as target cows.

At step S110, the individual identification unit 530 acquires N1 target images TG related to the back for one target cow. Here, N1 is an integer of 1 or greater. The value of N1 may be set to a value that is the same as or different from the number of registered embedding vectors related to each registered individual registered in the registered data 630. In addition, N1 may not be a predetermined value, but may be the number of the target images TG that have been acquired at that time point for the target cow. In the following description, the number of the registered embedding vectors related to each registered individual is referred to as “N2” for the purpose of distinction from the number N1 of the target images TG of the target cow. N1 and N2 are integers of 1 or greater. It should be noted that preferably N1 and N2 are each 2 or greater. Details of the process of step S110 are the same as the method of creating the target image TG for the registration target cow described in FIGS. 3 and 4.

At step S120, the individual identification unit 530 determines the embedding vector of each target image TG by using the trained deep metric learning model 620. Since there are N1 target images TG, N1 embedding vectors are obtained.

At step S130, the individual identification unit 530 calculates the distance between N1 embedding vectors and N2 registered embedding vectors related to each registered individual. As a result, N1×N2 distances are calculated for each registered individual. Since there are n registered individuals, a total of n×N1×N2 distances are calculated for one target cow.

At step S140, the individual identification unit 530 determines the individual ID of the target cow from the calculated distances.

FIG. 6 is a flowchart illustrating a specific procedure of step S140 in the first embodiment. At step S141, the individual identification unit 530 sequentially selects M distances from the smallest and closest one from among N1×N2 distances calculated for each registered individual. Here, M is an integer that is equal to or greater than 2 and smaller than N1×N2. Regarding the value of M, the user may directly set the value itself, or the value of M may be substantially set by designating the ratio of M to N1×N2. In the case where M is 2 or greater, it is preferable to set the integers N1 and N2 such that N1×N2 is 3 or greater. In the case of N1×N2=1, only one distance is calculated for each registered individual, and therefore step S141 may be omitted.

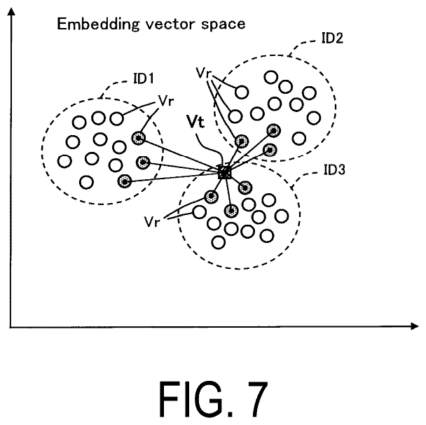

FIG. 7 is an explanatory diagram illustrating details of a process of step S140 in the first embodiment. Here, an exemplary case where n=3, N1=1, N2=10, and M=3 in the embedding vector space is illustrated. ID1 to ID3 are individual IDs of three registered individuals, and the circles included in the region surrounded by the broken line represent the positions of registered embedding vectors Vr of each registered individual. In addition, rectangles represent the positions of the embedding vectors Vt obtained for the target cow. The circles with hatching represent M registered embedding vectors Vr with small distances from the embedding vectors Vt of the target cow. Since M=3 holds in this example, three distances are sequentially selected from the smallest one for each registered individual.

At step S142, the individual identification unit 530 calculates the average value of M distances for each of n registered individuals. At step S143, the individual identification unit 530 determines the registered individual with the smallest average value of the distances as the individual of the target cow. As a result, the individual ID of that registered individual is determined to be the individual ID of the target cow. In the example illustrated in FIG. 7, the registered individual of ID3 has the smallest average value of the distances, and therefore it is determined that the individual ID of the target cow is ID3.

Through the above-described processes of FIGS. 6 and 7, the individual of the target cow can be determined from the smallest average value of M distances among N1×N2 distances related to each registered individual.

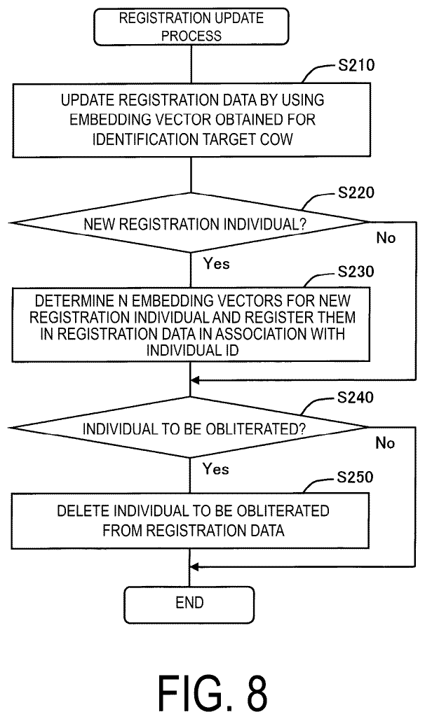

FIG. 8 is a flowchart illustrating a procedure of a registration update process. Preferably, this registration update process is performed on a regular basis, e.g., once daily.

At step S210, the individual identification unit 530 updates the registered data 630 by using the embedding vector Vt obtained for the target cow in the process of FIG. 6. For example, when N1=N2=N holds, that is, when a number N1 of the embedding vector Vt obtained for the target cow is equal to a number N2 of the registered embedding vectors Vr related to each registered individual in the registered data 630, the registered data 630 may be updated to replace N registered embedding vectors Vr with new N embedding vectors Vt. Alternatively, the registered data 630 may be updated to add N1 embedding vectors Vt obtained for the target cow without discarding the old registered embedding vector Vr.

Further, when q is an integer of 2 or greater, and the number N2 of the registered embedding vector Vr is equal to q×N1, the registered data 630 may be updated to discard the oldest N1 registered embedding vector Vr and add N1 embedding vectors Vt obtained anew for the target cow. In this manner, the registered data 630 can be updated to include the latest q×N1 registered embedding vector Vr at all times. In addition, instead of updating the registered data 630 by adding the same number of registered embedding vectors Vr for each time, the registered data 630 may be updated by adding a different number of registered embedding vectors Vr for each time. Specifically, the number of registrations may be counted, and the registered data 630 may be updated to include registered embedding vectors Vr for q times at all times.

At step S220, the individual identification unit 530 determines whether there is a new registered individual. The new registered individual is an individual that is not registered in the registered data 630. Whether there is a new registered individual is determined by the user. Alternatively, it is also possible to automatically determine that there is a new registered individual when the minimum value of the distance calculated for the target cow is equal to or greater than a preliminarily set threshold value. In this case, the user may input the individual ID of the new registered individual. Specifically, the individual identification unit 530 may notify the user of registration of a new individual to request input of the individual ID. When there is no new registered individual, the process proceeds to step S240 described later. On the other hand, when there is a new registered individual, the process proceeds to step S230, and the individual identification unit 530 determines N embedding vectors for the new registered individual and performs registration in the registered data 630 in association with the individual ID. Here, N may be a value equal to the number N1 of the embedding vector Vt for the target cow used at step S210, or may be a value equal to the number N2 of the registered embedding vectors Vr related to each registered individual in the registered data 630. The process of step S230 is substantially the same as the processes of steps S10, S40 and S50 in FIG. 2 described above.

At step S240, the individual identification unit 530 determines whether there is an individual to be obliterated in the registered data 630. Whether there is an individual to be obliterated is determined by the user. When there is no individual to be obliterated, the process of FIG. 8 is terminated. On the other hand, when there is an individual to be obliterated, the process proceeds to step S250, and the individual identification unit 530 deletes that individual data from the registered data 630. Through the process of FIG. 8, the registered data 630 can be maintained to the latest state.

According to the above-described first embodiment, with the deep metric learning model 620, the embedding vector Vt can be determined from the target image TG related to the back of the target cow, and the individual can be identified by using the distance between the embedding vector Vt and registered embedding vector Vr.

### B. Second Embodiment

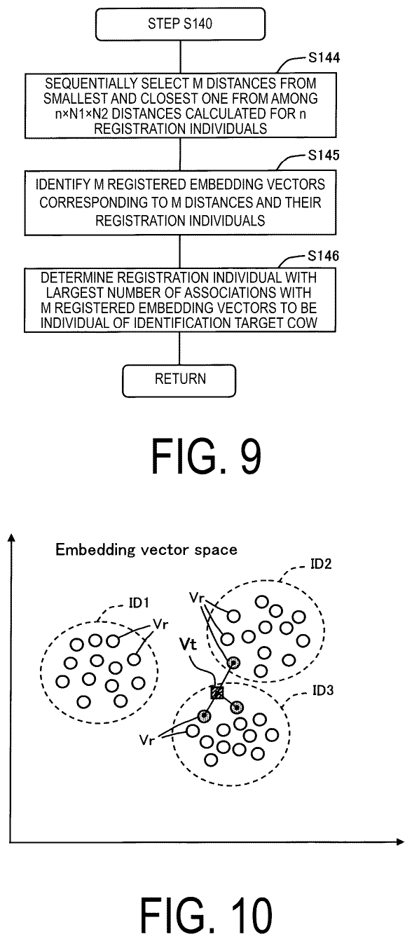

FIG. 9 is a flowchart illustrating a specific procedure of step S140 according to a second embodiment. The configuration of the apparatus of the second embodiment, and the details of the processes of FIGS. 2, 3, 5, and 8 are the same as those of the first embodiment. The second embodiment differs from the first embodiment only in the specific procedure of step S140 in FIG. 5.

At step S144 in FIG. 9, the individual identification unit 530 sequentially selects M distances from the smallest and closest one from among n×N1×N2 distances calculated for n registered individuals. Here, M is an integer that is 2 or greater and is smaller than n×N1×N2. In this case, it is preferable to set the integers n, N1 and N2 such that n×N1×N2 is 3 or greater.

FIG. 10 is a diagram illustrating details of the process of step S140 in the second embodiment, and illustrating an example in which n=3, N1=1, N2=10, and M=3 hold. The rectangles represent the positions of the embedding vectors Vt obtained for the target cow, and the circles with hatching represent M registered embedding vectors Vr with small distances from the embedding vectors Vt of the target cow. Since M=3 holds in this example, three distances are sequentially selected from the smallest one from among n×N1×N2 distances.

At step S145, the individual identification unit 530 specifies M registered embedding vectors Vr corresponding to M distances, and their registered individuals. In the example illustrated in FIG. 10, the individual ID related to two registered embedding vectors Vr corresponding to two distances is ID3, and the individual ID related to one registered embedding vector Vr corresponding to one distance is ID2.

At step S146, the individual identification unit 530 determines the registered individual with a largest number of associations with M registered embedding vectors Vr to be the individual of the target cow. In the example illustrated in FIG. 10, the registered individual whose individual ID is ID3 is determined to be the individual of the target cow.

The second embodiment can also achieve substantially the same effects as those of the first embodiment. In addition, through the processes of FIGS. 9 and 10, the individual of the target cow can be determined by using the smallest M distances among n×N1×N2 distances related to n registered individuals.

### C. Third Embodiment

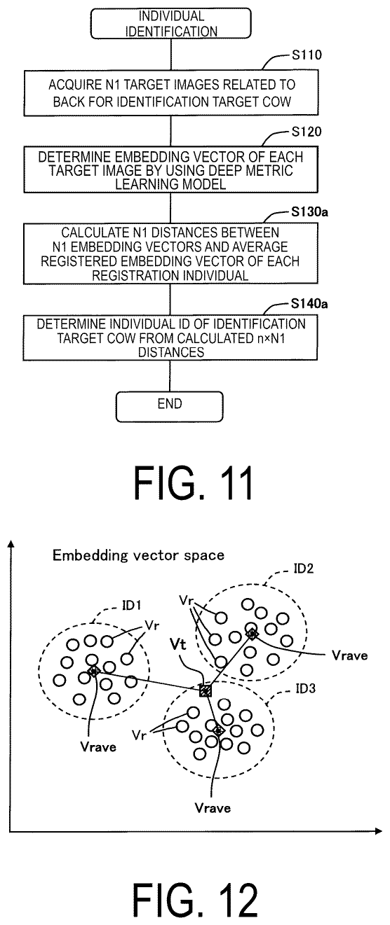

FIG. 11 is a flowchart illustrating a procedure of the individual identification process in a third embodiment. The configuration of the apparatus of the third embodiment, and the details of the processes of FIGS. 2 and 3 are the same as those of the first embodiment. The procedure of the processes in FIG. 11 is the same as that of the first embodiment except that steps S130 and S140 in FIG. 5 are replaced with steps S130a and S140a.

At step S130a in FIG. 11, the individual identification unit 530 calculates N1 distances between N1 embedding vectors obtained for the target cow and the average registered embedding vector related to each registered individual. The “average registered embedding vector” is an average vector of registered embedding vectors Vr of each registered individual registered in the registered data 630.

FIG. 12 is a diagram illustrating details of distance calculation in the third embodiment. Rhombuses represent average registered embedding vectors Vrave related to each registered individual. The average registered embedding vector Vrave may be calculated before the execution of step S140a. Since N1 embedding vectors have been obtained for the target cow, n×N1 distances are calculated for n registered individuals at step S140a.

At step S140a, the individual identification unit 530 determines the individual ID of the target cow from the calculated n×N1 distances. Specifically, for example, the registered individual with the minimum value among the n×N1 distances can be determined to be the individual of the target cow. This identification method can increase the process speed because the number of distance calculations is smaller than in the first embodiment and second embodiment.

Note that instead of determining the registered individual with the minimum value among the n×N1 distances to be the individual of the target cow, the individual may be determined in accordance with the procedure of step S140 in the first embodiment illustrated in FIG. 6. Specifically, it is possible to sequentially select M distances from the smallest and closest one from among the N1 distances calculated for each registered individual, calculate the average value of M distances related to each registered individual, and determine the registered individual with the smallest average value of the distances to be the individual of the target cow. In this case, M is an integer smaller than N1.

Alternatively, the individual may be determined in accordance with the procedure of step S140 of the second embodiment illustrated in FIG. 9. Specifically, it is possible to sequentially select M distances from the smallest and closest one from among the n×N1 distances calculated for n registered individuals, specify M average registered embedding vectors corresponding to M distances and their registered individuals, and determine the registered individual with a largest number of associations with the M average registered embedding vectors to be the individual of the target cow. In this case, M is an integer smaller than n×N1.

The third embodiment can also achieve substantially the same effects as those of the first embodiment. In addition, the above-described processes of FIGS. 11 and 12 can increase the process speed because the number of distance calculations is small.

### Other Aspects

The present disclosure is not limited to the embodiments described above, and may be implemented in various aspects without departing from the spirits of the disclosure. For example, the present disclosure can be achieved by the following aspects. Appropriate replacements or combinations may be made to the technical features in the above-described embodiments which correspond to the technical features in the aspects described below to solve some or all of the problems of the disclosure or to achieve some or all of the advantageous effects of the disclosure. If the technical feature is not described as essential in the specification, it can be deleted as appropriate.

(1) According to a first aspect of the present disclosure, a method of performing individual identification of a target animal is provided. The method including (a) acquiring a target image related to a back of the target animal, (b) determining an embedding vector from the target image by using a deep metric learning model, (c) calculating a distance between the registered embedding vector and the embedding vector by using registered data including a registered embedding vector generated in advance for each of a plurality of registered individuals, and (d) determining an individual of the target animal from among the plurality of registered individuals by using the distance.

According to this method, embedding vectors can be determined from the target image related to the back of the target animal by using a deep metric learning model, and the individual can be identified by using the distance between the embedding vector and the registered embedding vector.

(2) In the above-described method, (a) includes (a1) acquiring a back image related to the back of the target animal, (a2) detecting a plurality of key points from the back image by using an object recognition model, and (a3) generating the target image by cutting out a feature portion of the back from the back image with positions of the plurality of key points as a reference.

According to this method, a target image including a feature portion of the back can be acquired.

(3) In the above-described method, when each of N1 and N2 is an integer of 1 or greater, (b) includes determining N1 embedding vectors for N1 target images, (c) includes calculating N1×N2 distances between N2 registered embedding vectors related respectively to the plurality of registered individuals and the N1 embedding vectors, and (d) includes determining an individual of the target animal from among the plurality of registered individuals from the N1×N2 distances related respectively to the plurality of registered individuals.

According to this method, by using the N1×N2 distances related respectively to the plurality of registered individuals, the individual of the target animal can be determined from among a plurality of registered individuals.

(4) In the above-described method, when M is an integer that is equal to or greater than 2 and smaller than N1×N2, (d) includes (d1) determining an average value of M distances sequentially selected from the smallest and closest one from among the N1×N2 distances for each of the plurality of registered individuals, and (d2) determining to be the individual of the target animal a registered individual the average value of which is smallest among the plurality of registered individuals.

According to this method, the individual of the target animal can be determined from the smallest average value of the M distances in the N1×N2 distances related to each registered individual.

(5) In the above-described method, when n is the number of the plurality of registered individuals, and M is an integer that is 2 or greater and is smaller than n×N1×N2, (d) includes (d1) sequentially selecting M distances from the smallest and closest one from among n×N1×N2 distances obtained for the n registered individuals, (d2) specifying M registered embedding vectors corresponding to M distances, and specifying the registered individual associated with each of the M registered embedding vectors, and (d3) determining to be an individual of the target animal the registered individual with a largest number of associations with the M registered embedding vectors among the n registered individuals.

According to this method, by using the smallest M distances among n×N1×N2 distances related to n registered individuals, the individual of the target animal can be determined.

(6) In the above-described method, when N1 is an integer of 1 or greater, (b) includes determining N1 embedding vectors for N1 target images, (c) includes calculating N1 distances between the N1 embedding vectors and an average registered embedding vector, the average registered embedding vector being an average of a plurality of the registered embedding vectors related respectively to the plurality of registered individuals, and (d) includes determining an individual of the target animal from among the plurality of registered individuals from the N1 distances related respectively to the plurality of registered individuals.

According to this method, the process speed can be increased because the number of distance calculations can be small.

(7) According to a first aspect of the present disclosure, a non-transitory computer-readable storage medium storing a computer program, the computer program being configured to cause a processor to execute a process of performing individual identification of a target animal is provided. The computer program causes the processor to execute (a) a process of acquiring a target image related to a back of the target animal, (b) a process of determining an embedding vector from the target image by using a deep metric learning model, (c) a process of calculating a distance between the registered embedding vector and the embedding vector by using registered data including a registered embedding vector generated in advance for each of a plurality of registered individuals, and (d) a process of determining an individual of the target animal from among the plurality of registered individuals by using the distance.

Present disclosure can also be implemented in various forms other than those described above. For example, it can be implemented in the form of a device that implements the individual identification process, a non-transitory storage medium that records a computer program, or the like.

What is claimed is:

1. A method of performing individual identification of a target animal, the method comprising:
(a) acquiring a target image related to a back of the target animal;
(b) determining an embedding vector from the target image by using a deep metric learning model;
(c) calculating a distance between the registered embedding vector and the embedding vector by using registered data including a registered embedding vector generated in advance for each of a plurality of registered individuals; and
(d) determining an individual of the target animal from among the plurality of registered individuals by using the distance.

2. The method according to claim 1, wherein (a) includes:
(a1) acquiring a back image related to the back of the target animal;
(a2) detecting a plurality of key points from the back image by using an object recognition model; and
(a3) generating the target image by cutting out a feature portion of the back from the back image with positions of the plurality of key points as a reference.

3. The method according to claim 1, wherein
when each of N1 and N2 is an integer of 1 or greater,
(b) includes determining N1 embedding vectors for N1 target images;
(c) includes calculating N1×N2 distances between N2 registered embedding vectors related respectively to the plurality of registered individuals and the N1 embedding vectors; and
(d) includes determining a registered individual, to which the target animal corresponds, among the plurality of registered individuals based on the N1×N2 distances related respectively to the plurality of registered individuals.

4. The method according to claim 3, wherein
when M is an integer that is equal to or greater than 2 and smaller than N1×N2,
(d) includes:
(d1) determining an average value of M distances sequentially selected from the smallest and closest one from among the N1×N2 distances for each of the plurality of registered individuals; and
(d2) determining, to be the individual of the target animal, a registered individual the average value of which is smallest among the plurality of registered individuals.

5. The method according to claim 3, wherein
when n is a number of the plurality of registered individuals, and M is an integer that is 2 or greater and is smaller than n×N1×N2,
(d) includes:
(d1) sequentially selecting M distances from the smallest and closest one from among n×N1×N2 distances obtained for n registered individuals;
(d2) specifying M registered embedding vectors corresponding to M distances, and specifying the registered individual associated with each of the M registered embedding vectors; and
(d3) determining, to be an individual of the target animal, the registered individual with a largest number of associations with the M registered embedding vectors among the n registered individuals.

6. The method according to claim 1, wherein
when N1 is an integer of 1 or greater,
(b) includes determining N1 embedding vectors for N1 target images;
(c) includes calculating N1 distances between the N1 embedding vectors and an average registered embedding vector, the average registered embedding vector being an average of a plurality of the registered embedding vectors related respectively to the plurality of registered individuals; and
(d) includes determining a registered individual, to which the target animal corresponds, among the plurality of registered individuals based on the N1 distances related respectively to the plurality of registered individuals.

7. A non-transitory computer-readable storage medium storing a computer program, the computer program being configured to cause a processor to execute a process of performing individual identification of a target animal, the computer program causing the processor to execute:
(a) a process of acquiring a target image related to a back of the target animal;
(b) a process of determining an embedding vector from the target image by using a deep metric learning model;
(c) a process of calculating a distance between the registered embedding vector and the embedding vector by using registered data including a registered embedding vector generated in advance for each of a plurality of registered individuals; and
(d) a process of determining an individual of the target animal from among the plurality of registered individuals by using the distance.
